(19) United States
(12) Patent Application Publication
(10) Pub. No.: US 2012/0050478 A1
(43) Pub. Date: Mar. 1, 2012

(54) Method and System for Utilizing Multiple 3D Source Views for Generating 3D Image

(76) Inventors: Jeyhan Karaoguz, Irvine, CA (US); Nambi Seshadri, Irvine, CA (US); Xuemin Chen, Rancho Santa Fe, CA (US); Chris Boross, Sunnyvale, CA (US)

(21) Appl. No.: 13/077,893

(22) Filed: Mar. 31, 2011

Related U.S. Application Data
(60) Provisional application No. 61/439,119, filed on Feb. 3, 2011.
(60) Provisional application No. 61/377,867, filed on Aug. 27, 2010.

(51) Int. Cl. H04N 13/02

(52) U.S. Cl. 348/46; 348/E13.074

(57) ABSTRACT

A monoscopic three-dimensional (3D) video generation device, which comprises one or more depth sensors, may be operable to capture a plurality of two-dimensional (2D) image frames and corresponding depth information of an object from a plurality of different viewing angles. The captured 2D image frames and the captured corresponding depth information may be stored by the monoscopic 3D video generation device. One or more 3D models of the object corresponding to one or more of the different viewing angles may be generated by the monoscopic 3D video generation device utilizing the captured 2D image frames and the captured corresponding depth information. The monoscopic 3D video generation device may generate the 3D images of the object corresponding to the one or more viewing angles based on the generated one or more 3D models of the object.

### CROSS-REFERENCE TO RELATED APPLICATIONS/INCORPORATION BY REFERENCE

This patent application makes reference to, claims priority to, and claims benefit from:
U.S. Provisional Application Ser. No. 61/377,867, which was filed on Aug. 27, 2010; and
U.S. Provisional Application Ser. No. 61/439,119, which was filed on Feb. 3, 2011.

This application also makes reference to:
U.S. Patent Application Ser. No. 61/439,193 filed on Feb. 3, 2011;
U.S. patent application Ser. No. ______ (Attorney Docket No. 23461US03) filed on Mar. 31, 2011;
U.S. Patent Application Ser. No. 61/439,274 filed on Feb. 3, 2011;
U.S. patent application Ser. No. ______ (Attorney Docket No. 23462US03) filed on Mar. 31, 2011;
U.S. Patent Application Ser. No. 61/439,283 filed on Feb. 3, 2011;
U.S. patent application Ser. No. ______ (Attorney Docket No. 23463US03) filed on Mar. 31, 2011;
U.S. Patent Application Ser. No. 61/439,130 filed on Feb. 3, 2011;
U.S. patent application Ser. No. ______ (Attorney Docket No. 23464US03) filed on Mar. 31, 2011;
U.S. Patent Application Ser. No. 61/439,290 filed on Feb. 3, 2011;
U.S. patent application Ser. No. ______ (Attorney Docket No. 23465US03) filed on Mar. 31, 2011;
U.S. Patent Application Ser. No. 61/439,297 filed on Feb. 3, 2011;
U.S. patent application Ser. No. ______ (Attorney Docket No. 23467US03) filed on Mar. 31, 2011;
U.S. Patent Application Ser. No. 61/439,201 filed on Feb. 3, 2011;
U.S. Patent Application Ser. No. 61/439,209 filed on Feb. 3, 2011;
U.S. Patent Application Ser. No. 61/439,113 filed on Feb. 3, 2011;
U.S. patent application Ser. No. ______ (Attorney Docket No. 23472US03) filed on Mar. 31, 2011;
U.S. Patent Application Ser. No. 61/439,103 filed on Feb. 3, 2011;
U.S. patent application Ser. No. ______ (Attorney Docket No. 23473US03) filed on Mar. 31, 2011;
U.S. Patent Application Ser. No. 61/439,083 filed on Feb. 3, 2011;
U.S. patent application Ser. No. ______ (Attorney Docket No. 23474US03) filed on Mar. 31, 2011;
U.S. Patent Application Ser. No. 61/439,301 filed on Feb. 3, 2011; and
U.S. patent application Ser. No. ______ (Attorney Docket No. 23475US03) filed on Mar. 31, 2011.

Each of the above stated applications is hereby incorporated herein by reference in its entirety.

### FIELD OF THE INVENTION

Certain embodiments of the invention relate to video processing. More specifically, certain embodiments of the invention relate to a method and system for utilizing multiple 3D source views for generating 3D image.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV (DTV), a 3D video is often desirable because it is often more realistic to viewers than the 2D counterpart. A 3D video comprises a left view video and a right view video.

Various video encoding standards, for example, MPEG-1, MPEG-2, MPEG-4, MPEG-C part 3, H.263, H.264/MPEG-4 advanced video coding (AVC), multi-view video coding (MVC) and scalable video coding (SVC), have been established for encoding digital video sequences in a compressed manner. For example, the MVC standard, which is an extension of the H.264/MPEG-4 AVC standard, may provide efficient coding of a 3D video. The SVC standard, which is also an extension of the H.264/MPEG-4 AVC standard, may enable transmission and decoding of partial bitstreams to provide video services with lower temporal or spatial resolutions or reduced fidelity, while retaining a reconstruction quality that is similar to that achieved using the H.264/MPEG-4 AVC.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for utilizing multiple 3D source views for generating 3D image, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram that illustrates an exemplary monoscopic 3D video camera embodying aspects of the present invention, compared with a conventional stereoscopic video camera.

FIG. 1B is a block diagram that illustrates exemplary processing of depth information and 2D color information to generate a 3D image, in accordance with an embodiment of the invention.

FIG. 2A is a block diagram that illustrates exemplary capturing of 2D image frames and corresponding depth information of an object continuously from different viewing angles, in accordance with an embodiment of the invention.

FIG. 2B is a block diagram that illustrates exemplary generation of 3D images of an object corresponding to one or more viewing angles, in accordance with an embodiment of the invention.

FIG. 3 is a block diagram illustrating an exemplary monoscopic 3D video camera that is operable to utilize multiple 3D source views for generating 3D image, in accordance with an embodiment of the invention.

FIG. 4 is a flow chart illustrating exemplary steps for utilizing multiple 3D source views for generating 3D image, in accordance with an embodiment of the invention.

### DETAILED DESCRIPTION OF THE INVENTION

Certain embodiments of the invention can be found in a method and system for utilizing multiple 3D source views for generating 3D image. In various embodiments of the invention, a monoscopic three-dimensional (3D) video generation device, which comprises one or more depth sensors, may be operable to capture a plurality of two-dimensional (2D) image frames and corresponding depth information of an object from a plurality of different viewing angles. The captured plurality of 2D image frames and the captured corresponding depth information may be utilized by the monoscopic 3D video generation device to generate 3D images of the object corresponding to one or more of the plurality of different viewing angles. In this regard, the monoscopic 3D video generation device may store the captured plurality of 2D image frames and the captured corresponding depth information. The plurality of 2D image frames may be captured via, for example, one or more image sensors in the monoscopic 3D video generation device. The corresponding depth information may be captured via, for example, the one or more depth sensors in the monoscopic 3D video generation device. The plurality of 2D image frames and the corresponding depth information may be captured while the monoscopic 3D video generation device is continuously changing positions with respect to the object. The changed positions may comprise, for example, positions above, below and/or around the object.

The monoscopic 3D video generation device may be operable to determine the one or more viewing angles for generating the 3D images of the object. One or more 3D models of the object corresponding to the determined one or more viewing angles may be generated by the monoscopic 3D video generation device utilizing the captured plurality of 2D image frames and the captured corresponding depth information. The monoscopic 3D video generation device may generate the 3D images of the object corresponding to the determined one or more viewing angles based on the generated one or more 3D models of the object. The monoscopic 3D video generation device may be configured to output the 3D images of the object to a display in the monoscopic 3D video generation device and/or output the 3D images of the object externally to a 3D video rendering device for rendering the 3D images of the object.

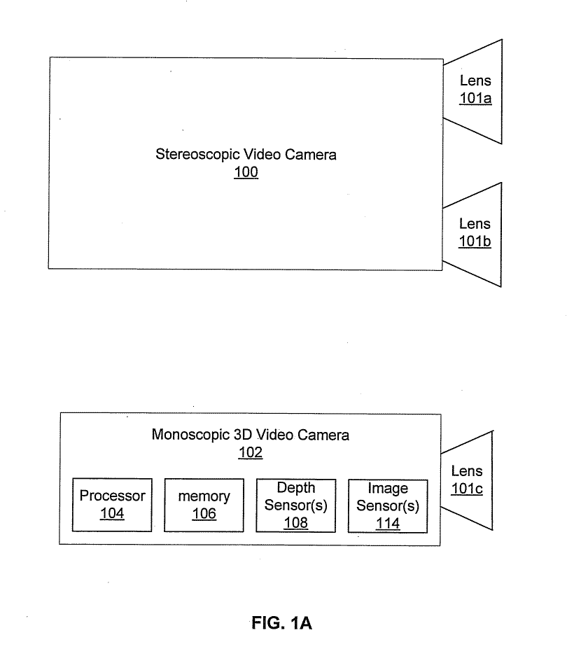

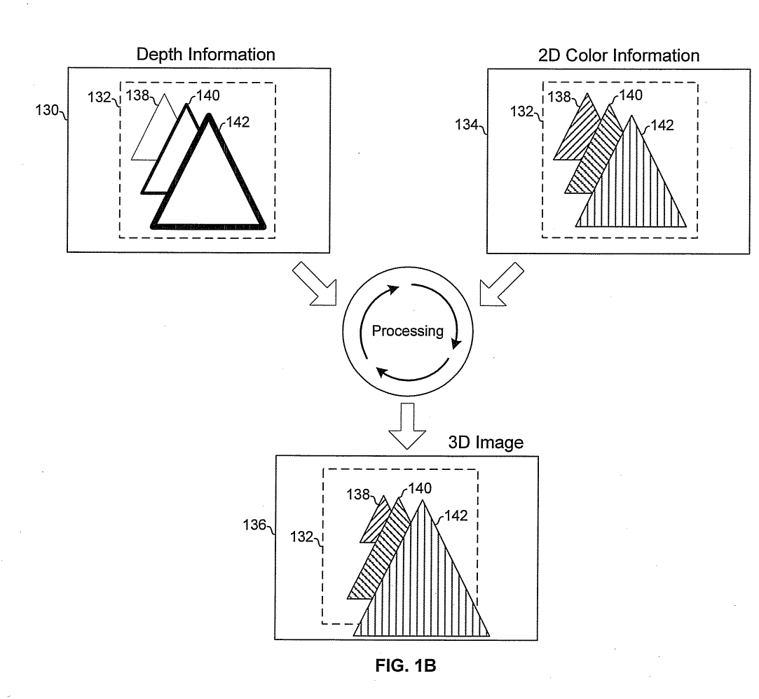

FIG. 1A is a block diagram that illustrates an exemplary monoscopic 3D video camera embodying aspects of the present invention, compared with a conventional stereoscopic video camera. Referring to FIG. 1A, there is shown a stereoscopic video camera 100 and a monoscopic 3D video camera 102. The stereoscopic video camera 100 may comprise two lenses 101a and 101b. Each of the lenses 101a and 101b may capture images from a different viewpoint and images captured via the two lenses 101a and 101b may be combined to generate a 3D image. In this regard, electromagnetic (EM) waves in the visible spectrum may be focused on a first one or more image sensors by the lens 101a (and associated optics) and EM waves in the visible spectrum may be focused on a second one or more image sensors by the lens (and associated optics) 101b.

The monoscopic 3D video camera 102 may comprise a processor 104, a memory 106, one or more depth sensors 108 and one or more image sensors 114. The monoscopic 3D or single-view video camera 102 may capture images via a single viewpoint corresponding to the lens 101c. In this regard, EM waves in the visible spectrum may be focused on one or more image sensors 114 by the lens 101c. The monoscopic 3D video camera 102 may also capture depth information via the lens 101c (and associated optics).

The processor 104 may comprise suitable logic, circuitry, interfaces, and/or code that may be operable to manage operation of various components of the monoscopic 3D video camera 102 and perform various computing and processing tasks.

The memory 106 may comprise, for example, DRAM, SRAM, flash memory, a hard drive or other magnetic storage, or any other suitable memory devices. For example, SRAM may be utilized to store data utilized and/or generated by the processor 104 and a hard-drive and/or flash memory may be utilized to store recorded image data and depth data.

The depth sensor(s) 108 may each comprise suitable logic, circuitry, interfaces, and/or code that may be operable to detect EM waves in the infrared spectrum and determine depth information based on reflected infrared waves. For example, depth information may be determined based on time-of-flight of infrared waves transmitted by an emitter (not shown) in the monoscopic 3D video camera 102 and reflected back to the depth sensor(s) 108. Depth information may also be determined using a structured light method, for example. In such instance, a pattern of light such as a grid of infrared waves may be projected at a known angle onto an object by a light source such as a projector. The depth sensor(s) 108 may detect the deformation of the light pattern such as the infrared light pattern on the object. Accordingly, depth information for a scene may be determined or calculated using, for example, a triangulation technique.

The image sensor(s) 114 may each comprise suitable logic, circuitry, interfaces, and/or code that may be operable to convert optical signals to electrical signals. Each image sensor 114 may comprise, for example, a charge coupled device (CCD) image sensor or a complimentary metal oxide semiconductor (CMOS) image sensor. Each image sensor 114 may capture brightness, luminance and/or chrominance information.

In exemplary operation, the monoscopic 3D video camera 102 may be operable to capture a plurality of 2D image frames and corresponding depth information of an object from a plurality of different viewing angle, utilizing the image sensor(s) 114 and the depth sensor(s) 108, respectively. The captured 2D image frames and the captured corresponding depth information may be stored in the memory 106. The processor 104 may be operable to determine one or more of the plurality of different viewing angles for generating 3D images of the object. One or more 3D models of the object corresponding to the determined one or more viewing angles may be generated by the processor 104 utilizing the captured 2D image frames and the captured corresponding depth information. The processor 104 may then generate the 3D images of the object corresponding to the determined one or more viewing angles based on the generated one or more 3D models of the object.

FIG. 1B is a block diagram that illustrates exemplary processing of depth information and 2D color information to generate a 3D image, in accordance with an embodiment of the invention. Referring to FIG. 1B, there is shown a frame of depth information 130, a frame of 2D color information 134 and a frame of 3D image 136. The frame of depth information 130 may be captured by the depth sensor(s) 108 and the frame of 2D color information 134 may be captured by the image sensor(s) 114. The frame of depth information 130 may be utilized while processing the frame of 2D color information 134 by the processor 104 to generate the frame of 3D image 136. The dashed line 132 may indicate a reference plane to illustrate the 3D image. In the frame of depth information 130, a line weight is used to indicate depth. In this regard, for example, the heavier the line, the closer that portion of the frame 130 is to a monoscopic 3D video camera 102. Therefore, the object 138 is farthest from the monoscopic 3D video camera 102, the object 142 is closest to the monoscopic 3D video camera, and the object 140 is at an intermediate depth. In various embodiments of the invention, the depth information may be mapped to a grayscale or pseudo-grayscale image by the processor 104.

The image in the frame 134 is a conventional 2D image. A viewer of the frame 134 perceives the same depth between the viewer and each of the objects 138, 140 and 142. That is, each of the objects 138, 140, 142 appears to reside on the reference plane 132. The image in the frame 136 is a 3D image. A viewer of the frame 136 perceives the object 138 being further from the viewer, the object 142 being closest to the viewer, and the object 140 being at an intermediate depth. In this regard, the object 138 appears to be behind the reference plane 132, the object 140 appears to be on the reference plane 132, and the object 142 appears to be in front of the reference plane 132.

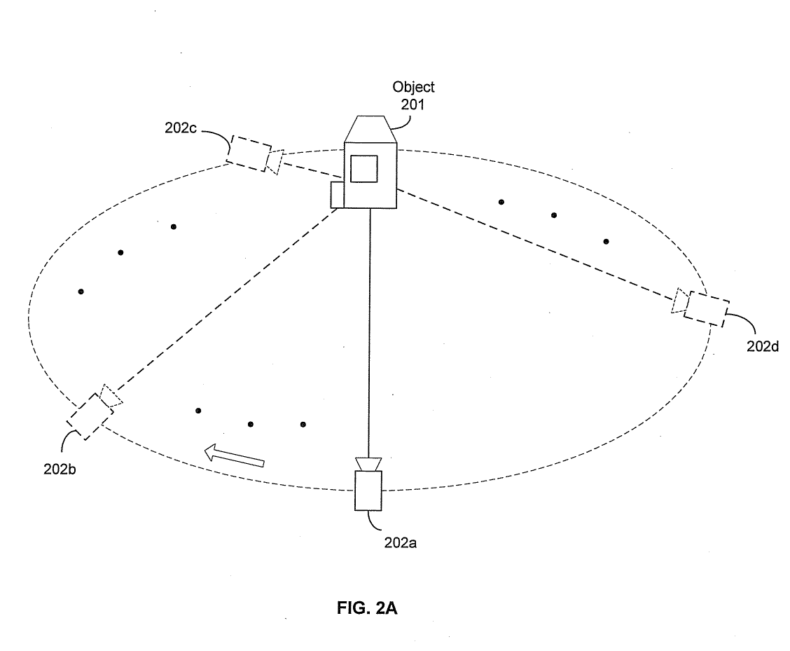

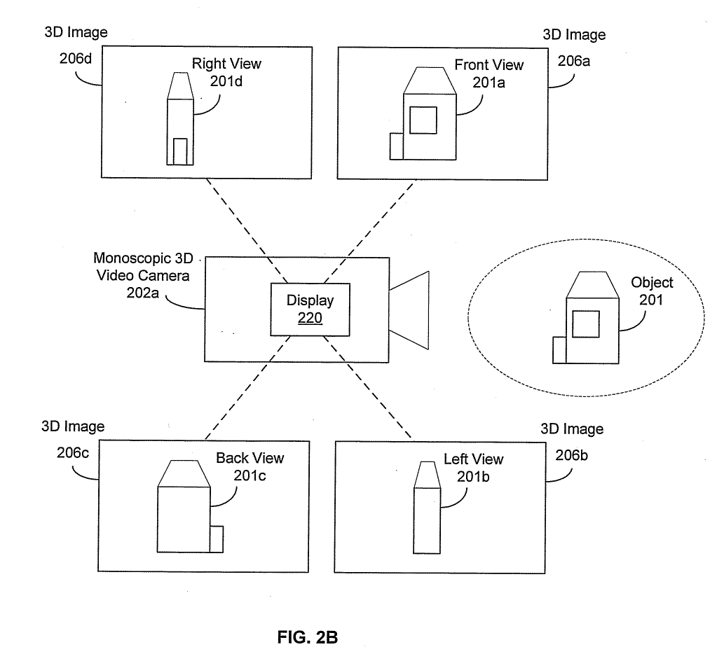

FIG. 2A is a block diagram that illustrates exemplary capturing of 2D image frames and corresponding depth information of an object continuously from different viewing angles, in accordance with an embodiment of the invention. Referring to FIG. 2A, there is shown an object 201 and a monoscopic 3D video camera 202a.

The monoscopic 3D video camera 202a may comprise suitable logic, circuitry, interfaces and/or code that may be operable to capture 2D image frames and corresponding depth information. The monoscopic 3D video camera 202a may be substantially similar to the monoscopic 3D video camera 102 in FIG. 1A. In an exemplary embodiment of the invention, the monoscopic 3D video camera 202a may move around and change camera positions with respect to the object 201 while capturing the 2D image frames and the corresponding depth information of the object 201. For example, the monoscopic 3D video camera 202a may change camera positions continuously as illustrated by the positions of monoscopic 3D video cameras 202a-202d.

In exemplary operation, the monoscopic 3D video camera 202a may be operable to capture a plurality of 2D image frames and corresponding depth information of the object 201 from a plurality of different view angles, while the monoscopic 3D video camera 202a is continuously changing camera positions as illustrated by the positions of the monoscopic 3D video cameras 202a-202d. In such instance, each of the monoscopic 3D video cameras 202a-202d may capture the 2D image frames and the corresponding depth information from a different viewing angle. The captured plurality of 2D image frames and the captured plurality of corresponding depth information may be stored by the monoscopic 3D video camera 202a. The stored 2D image frames and the stored corresponding depth information may then be utilized by the monoscopic 3D video camera 202a to generate 3D images of the object 201 corresponding to one or more of the plurality of different viewing angles. Exemplary generation of the 3D images of the object 201 corresponding to the one or more viewing angles are described below with respect to FIG. 2B.

Although a monoscopic 3D video camera 202a is illustrated in FIG. 2A, the invention may not be so limited. Accordingly, other monoscopic 3D generation device such as a monoscopic 3D camcorder, which generates 3D video content in 2D-plus-depth formats, may be illustrated without departing from the spirit and scope of various embodiments of the invention.

In the exemplary embodiment of the invention illustrated in FIG. 2A, four video cameras 202a-202d with camera positions around the object 201 are shown. Notwithstanding, the invention is not so limited and the camera positions may be, for example, above the object 201, below the object 201 and/or at other areas around the object 201.

FIG. 2B is a block diagram that illustrates exemplary generation of 3D images of an object corresponding to one or more viewing angles, in accordance with an embodiment of the invention. Referring to FIG. 2B, there is shown a monoscopic 3D video camera 202a and an object 201. The monoscopic 3D video camera 202a and the object 201 are described with respect to FIG. 2A. The monoscopic 3D video camera 202a may comprise a display 220. In an exemplary embodiment of the invention, the monoscopic 3D video camera 202a may be configured to output 3D images such as the 3D images 206a-206d of the object 201 to the display 220. The 3D image 206a may comprise a front view 201a of the object 201, the 3D image 206b may comprise a left view 201b of the object 201, the 3D image 206c may comprise a back view 201c of the object 201 and the 3D image 206d may comprise a right view 201d of the object 201.

In exemplary operation, the monoscopic 3D video camera 202a may be operable to determine one or more viewing angles for generating 3D images of the object 201. For example, a front view, a left view, a back view and a right view may be determined for generating the 3D images 206a-206d, respectively. In this regard, a front view model, a left view model, a back view model and a right view model of the object 201 may be generated by the monoscopic 3D video camera 202a, utilizing the captured plurality of 2D image frames and the captured corresponding depth information. The monoscopic 3D video camera 202a may then generate the 3D image 206a, which comprises the front view 201a, based on the front view model of the object 201. The 3D image 206b, which comprises the left view 201b may be generated by the monoscopic 3D video camera 202a, based on the left view model of the object 201. The 3D image 206c, which comprises the back view 201c may be generated by the monoscopic 3D video camera 202a, based on the back view model of the object 201. The 3D image 206d, which comprises the right view 201d may be generated by the monoscopic 3D video camera 202a, based on the right view model of the object 201.

Although the 3D images 206a-206d corresponding to the front view, the left view, the back view and the right view are illustrated in FIG. 2B, the invention may not be so limited. Accordingly, other 3D images of the object 201 corresponding to other viewing angles may be illustrated without departing from the spirit and scope of various embodiments of the invention.

In the exemplary embodiment of the invention illustrated in FIG. 2B, the monoscopic 3D video camera 202a is configured to output 3D images of the object 201 to the display 220 in the monoscopic 3D video camera 202a. Notwithstanding, the invention is not so limited and the monoscopic 3D video camera 202a may be configured to output the 3D images of the object 201 externally to a 3D video rendering device for rendering the 3D images of the object 201.

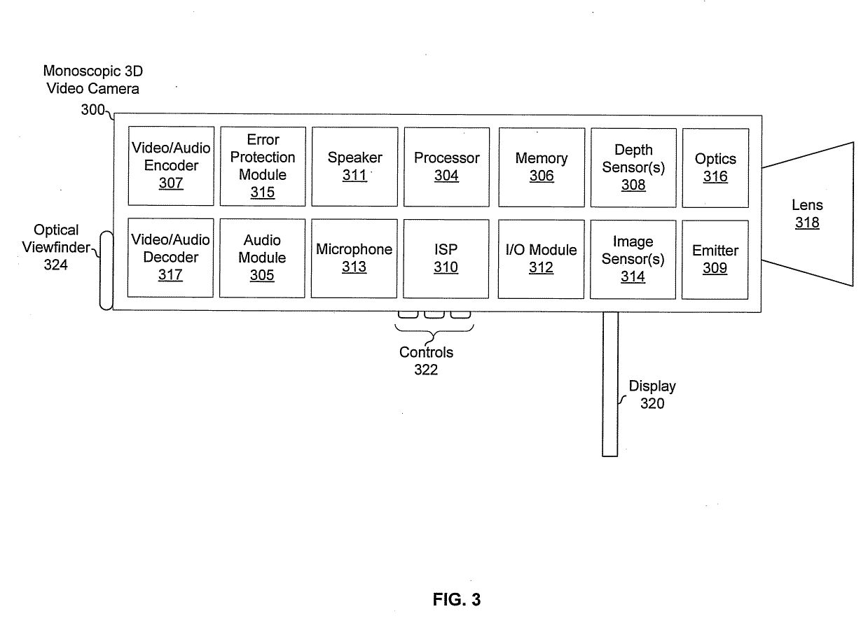

FIG. 3 is a block diagram illustrating an exemplary monoscopic 3D video camera that is operable to utilize multiple 3D source views for generating 3D image, in accordance with an embodiment of the invention. Referring to FIG. 3, there is shown a monoscopic 3D video camera 300. The monoscopic 3D video camera 300 may comprise a processor 304, a memory 306, one or more depth sensors 308, an emitter 309, an image signal processor (ISP) 310, an input/output (I/O) module 312, one or more image sensors 314, an optics 316, a speaker 311, a microphone 313, a video/audio encoder 307, a video/audio decoder 317, an audio module 305, an error protection module 315, a lens 318, a plurality of controls 322, an optical viewfinder 324 and a display 320. The monoscopic 3D video camera 300 may be substantially similar to the monoscopic 3D video camera 102 in FIG. 1A.

The processor 304 may comprise suitable logic, circuitry, interfaces, and/or code that may be operable to coordinate operation of various components of the monoscopic 3D video camera 300. The processor 304 may, for example, run an operating system of the monoscopic 3D video camera 300 and control communication of information and signals between components of the monoscopic 3D video camera 300. The processor 304 may execute code stored in the memory 306. In an exemplary embodiment of the invention, the processor 304 may be operable to generate one or more 3D models of an object, such as the object 201, corresponding to one or more viewing angles of the object 201. The one or more 3D models may be generated utilizing a plurality of 2D image frames and a corresponding depth information stored in the memory 306, where the stored 2D image frames and the stored corresponding depth information may be captured from a plurality of different viewing angles of the object 201. In this regard, the processor 304 may be operable to generate 3D images of the object 201 corresponding to the one or more viewing angles based on the generated one or more 3D models of the object 201.

The memory 306 may comprise, for example, DRAM, SRAM, flash memory, a hard drive or other magnetic storage, or any other suitable memory devices. For example, SRAM may be utilized to store data utilized and/or generated by the processor 304 and a hard-drive and/or flash memory may be utilized to store recorded image data and depth data. In an exemplary embodiment of the invention, the memory 306 may be operable to store a plurality of 2D image frames and corresponding depth information of an object such as the object 201, where the 2D image frames and the corresponding depth information may be captured from a plurality of different viewing angles of the object 201. The memory 306 may also store one or more 3D models corresponding to one or more of the plurality of different viewing angles of the object 201, where the 3D model(s) may be generated by the processor 304.

The depth sensor(s) 308 may each comprise suitable logic, circuitry, interfaces, and/or code that may be operable to detect EM waves in the infrared spectrum and determine depth information based on reflected infrared waves. For example, depth information may be determined based on time-of-flight of infrared waves transmitted by the emitter 309 and reflected back to the depth sensor(s) 308. Depth information may also be determined using a structured light method, for example. In such instance, a pattern of light such as a grid of infrared waves may be projected at a known angle onto an object by a light source such as a projector. The depth sensor(s) 308 may detect the deformation of the light pattern such as the infrared light pattern on the object. Accordingly, depth information for a scene may be determined or calculated using, for example, a triangulation technique.

The image signal processor or image sensor processor (ISP) 310 may comprise suitable logic, circuitry, interfaces, and/or code that may be operable to perform complex processing of captured image data and captured corresponding depth data. The ISP 310 may perform a plurality of processing techniques comprising, for example, filtering, demosaic, Bayer interpolation, lens shading correction, defective pixel correction, white balance, image compensation, color transformation and/or post filtering.

The audio module 305 may comprise suitable logic, circuitry, interfaces and/or code that may be operable to perform various audio functions of the monoscopic 3D video camera 300. In an exemplary embodiment of the invention, the audio module 305 may perform noise cancellation and/or audio volume level adjustment for a 3D scene.

The video/audio encoder 307 may comprise suitable logic, circuitry, interfaces and/or code that may be operable to perform video encoding and/or audio encoding functions. For example, the video/audio encoder 307 may encode or compress captured 2D video images and corresponding depth information and/or audio data for transmission to a 3D video rendering device.

The video/audio decoder 317 may comprise suitable logic, circuitry, interfaces and/or code that may be operable to perform video decoding and/or audio decoding functions.

The error protection module 315 may comprise suitable logic, circuitry, interfaces and/or code that may be operable to perform error protection functions for the monoscopic 3D video camera 300. For example, the error protection module 315 may provide error protection to encoded 2D video images and corresponding depth information and/or encoded audio data for transmission to a 3D video rendering device.

The input/output (I/O) module 312 may comprise suitable logic, circuitry, interfaces, and/or code that may enable the monoscopic 3D video camera 300 to interface with other devices in accordance with one or more standards such as USB, PCI-X, IEEE 1394, HDMI, DisplayPort, and/or analog audio and/or analog video standards. For example, the I/O module 312 may be operable to send and receive signals from the controls 322, output video to the display 320, output audio to the speaker 311, handle audio input from the microphone 313, read from and write to cassettes, flash cards, solid state drives, hard disk drives or other external memory attached to the monoscopic 3D video camera 300, and/or output audio and/or video externally via one or more ports such as a IEEE 1394 port, a HDMI and/or an USB port for transmission and/or rendering.

The image sensor(s) 314 may each comprise suitable logic, circuitry, interfaces, and/or code that may be operable to convert optical signals to electrical signals. Each image sensor 314 may comprise, for example, a charge coupled device (CCD) image sensor or a complimentary metal oxide semiconductor (CMOS) image sensor. Each image sensor 314 may capture brightness, luminance and/or chrominance information.

The optics 316 may comprise various optical devices for conditioning and directing EM waves received via the lens 318. The optics 316 may direct EM waves in the visible spectrum to the image sensor(s) 314 and direct EM waves in the infrared spectrum to the depth sensor(s) 308. The optics 316 may comprise, for example, one or more lenses, prisms, luminance and/or color filters, and/or mirrors.

The lens 318 may be operable to collect and sufficiently focus electromagnetic (EM) waves in the visible and infrared spectra.

The display 320 may comprise a LCD display, a LED display, an organic LED (OLED) display and/or other digital display on which images recorded via the monoscopic 3D video camera 300 may be displayed. In an embodiment of the invention, the display 320 may be operable to display 3D images.

The controls 322 may comprise suitable logic, circuitry, interfaces, and/or code that may enable a user to interact with the monoscopic 3D video camera 300. For example, the controls 322 may enable the user to control recording and playback. In an embodiment of the invention, the controls 322 may enable the user to select whether the monoscopic 3D video camera 300 records in 2D mode or 3D mode.

The optical viewfinder 324 may enable a user to view or see what the lens 318 “sees,” that is, what is “in frame”.

In operation, the image sensor(s) 314 may capture brightness, luminance and/or chrominance information associated with a 2D video image frame and the depth sensor(s) 308 may capture corresponding depth information. In various embodiments of the invention, various color formats, such as RGB and YCrCb, may be utilized. The depth information may be stored in the memory 306 as metadata or as an additional layer of information, which may be utilized when rendering a 3D video image from the 2D image information.

In an exemplary embodiment of the invention, the monoscopic 3D video camera 300 may be operable to capture a plurality of 2D image frames and corresponding depth information of the object 201 from a plurality of different viewing angle, utilizing the image sensor(s) 314 and the depth sensor(s) 308, respectively. In this regard, the 2D image frames and the corresponding depth information may be captured while the monoscopic 3D video camera 300 is continuously changing camera positions with respect to the object 201. The monoscopic 3D video camera 300 may store the captured 2D image frames and the captured corresponding depth information in the memory 306.

In an exemplary embodiment of the invention, the processor 304 may be operable to determine one or more of the plurality of different viewing angles for generating 3D images of the object 201. One or more 3D models of the object 201 corresponding to the determined one or more viewing angles may be generated by the processor 304 utilizing the captured 2D image frames and the captured corresponding depth information. The processor 304 may then generate the 3D images of the object 201 corresponding to the determined one or more viewing angles based on the generated one or more 3D models of the object 201. The monoscopic 3D video camera 300 may be configured to output, via the I/O module 312, the 3D images of the object 201 to the display 320. The monoscopic 3D video camera 300 may also be configured to output, via the I/O module 312, the 3D images of the object 201 externally to a 3D video rendering device for rendering the 3D images of the object 201.

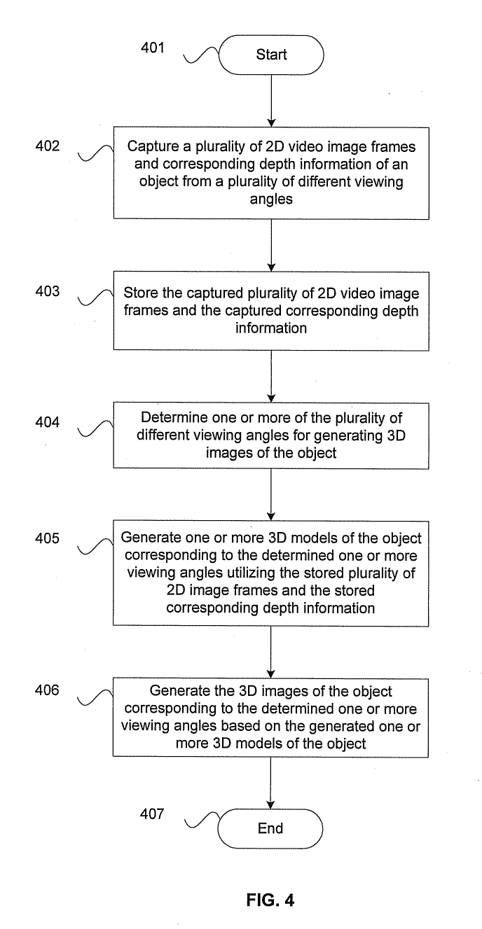

FIG. 4 is a flow chart illustrating exemplary steps for utilizing multiple 3D source views for generating 3D image, in accordance with an embodiment of the invention. Referring to FIG. 4, the exemplary steps start at step 401. In step 402, the monoscopic 3D video camera 300 may be operable to capture a plurality of 2D image frames and corresponding depth information of an object such as the object 201 from a plurality of different viewing angle, utilizing the image sensor(s) 314 and the depth sensor(s) 308, respectively. In this regard, for example, the 2D image frames and the corresponding depth information may be captured while the monoscopic 3D video camera 300 is continuously changing camera positions with respect to the object 201. In step 403, the monoscopic 3D video camera 300 may store the captured 2D image frames and the captured corresponding depth information in the memory 306. In step 404, the processor 304 in the monoscopic 3D video camera 300 may be operable to determine one or more of the plurality of different viewing angles for generating 3D images of the object 201. In step 405, one or more 3D models of the object 201 corresponding to the determined one or more viewing angles may be generated by the processor 304 utilizing the stored plurality of 2D image frames and the stored corresponding depth information. In step 406, the processor 304 may generate the 3D images of the object 201 corresponding to the determined one or more viewing angles based on the generated one or more 3D models of the object 201. The exemplary steps may proceed to the end step 407.

In various embodiments of the invention, a monoscopic 3D video generation device such as the monoscopic 3D video camera 300 may comprise one or more depth sensors 308. The monoscopic 3D video camera 300 may be operable to capture a plurality of two-dimensional 2D image frames and corresponding depth information of an object such as the object 201 from a plurality of different viewing angles. The captured plurality of 2D image frames and the captured corresponding depth information may be utilized by a processor 304 in the monoscopic 3D video camera 300 to generate 3D images of the object 201 corresponding to one or more of the plurality of different viewing angles. In this regard, the captured plurality of 2D image frames and the captured corresponding depth information may be stored in the memory 306 in the monoscopic 3D video camera 300. The plurality of 2D image frames may be captured via, for example, one or more image sensors 314 in the monoscopic 3D video camera 300. The corresponding depth information may be captured via, for example, the one or more depth sensors 308. The plurality of 2D image frames and the corresponding depth information may be captured while the monoscopic 3D video camera 300 is continuously changing positions with respect to the object 201. The changed positions may comprise, for example; positions above, below and/or around the object 201.

The processor 304 in the monoscopic 3D video camera 300 may be operable to determine the one or more viewing angles for generating the 3D images of the object 201. One or more 3D models of the object 201 corresponding to the determined one or more viewing angles may be generated by the processor 304 utilizing the captured plurality of 2D image frames and the captured corresponding depth information. The processor 304 may generate the 3D images of the object 201 corresponding to the determined one or more viewing angles based on the generated one or more 3D models of the object 201. The monoscopic 3D video camera 300 may be configured to output, via an I/O module 312, the 3D images of the object 201 to a display 320 in the monoscopic 3D video camera 300. The monoscopic 3D video camera 300 may also be configured to output, via the I/O module 312, the 3D images of the object 201 externally to a 3D video rendering device for rendering the 3D images of the object 201.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for utilizing multiple 3D source views for generating 3D image.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
in a monoscopic three-dimensional (3D) video generation device comprising one or more depth sensors:
capturing a plurality of two-dimensional (2D) image frames and corresponding depth information of an object from a plurality of different viewing angles; and
generating 3D images of said object corresponding to one or more of said plurality of different viewing angles utilizing said captured plurality of 2D image frames and said captured corresponding depth information of said object.

2. The method according to claim 1, comprising storing said captured plurality of 2D image frames and said captured corresponding depth information.

3. The method according to claim 1, comprising:
capturing said plurality of 2D image frames via one or more image sensors in said monoscopic 3D video generation device; and
capturing said corresponding depth information via said one or more depth sensors in said monoscopic 3D video generation device.

4. The method according to claim 1, comprising capturing said plurality of 2D image frames and said corresponding depth information while said monoscopic 3D video generation device is continuously changing positions with respect to said object.

5. The method according to claim 4, wherein said changed positions comprise positions above, below and/or around said object.

6. The method according to claim 1, comprising determining said one or more viewing angles for generating said 3D images of said object.

7. The method according to claim 6, comprising generating one or more 3D models of said object corresponding to said determined one or more viewing angles respectively utilizing said captured plurality of 2D image frames and said captured corresponding depth information.

8. The method according to claim 7, comprising generating said 3D images of said object corresponding to said determined one or more viewing angles based on said generated one or more 3D models of said object.

9. The method according to claim 1, comprising configuring said monoscopic 3D video generation device to output said 3D images of said object to a display in said monoscopic 3D video generation device.

10. The method according to claim 1, comprising configuring said monoscopic 3D video generation device to output said 3D images of said object externally to a 3D video rendering device for rendering said 3D images of said object.

11. A system for processing video, the system comprising:
one or more processors and/or circuits for use in a monoscopic three-dimensional (3D) video generation device comprising one or more depth sensors, wherein said one or more processors and/or circuits are operable to:
capture a plurality of two-dimensional (2D) image frames and corresponding depth information of an object from a plurality of different viewing angles; and
generate 3D images of said object corresponding to one or more of said plurality of different viewing angles utilizing said captured plurality of 2D image frames and said captured corresponding depth information of said object.

12. The system according to claim 11, wherein said one or more processors and/or circuits are operable to store said captured plurality of 2D image frames and said captured corresponding depth information.

13. The system according to claim 11, wherein said one or more processors and/or circuits are operable to:
capture said plurality of 2D image frames via one or more image sensors in said monoscopic 3D video generation device; and
capture said corresponding depth information via said one or more depth sensors in said monoscopic 3D video generation device.

14. The system according to claim 11, wherein said one or more processors and/or circuits are operable to capture said plurality of 2D image frames and said corresponding depth information while said monoscopic 3D video generation device is continuously changing positions with respect to said object.

15. The system according to claim 14, wherein said changed positions comprise positions above, below and/or around said object.

16. The system according to claim 11, wherein said one or more processors and/or circuits are operable to determine said one or more viewing angles for generating said 3D images of said object.

17. The system according to claim 16, wherein said one or more processors and/or circuits are operable to generate one or more 3D models of said object corresponding to said determined one or more viewing angles respectively utilizing said captured plurality of 2D image frames and said captured corresponding depth information.

18. The system according to claim 17, wherein said one or more processors and/or circuits are operable to generate said 3D images of said object corresponding to said determined one or more viewing angles based on said generated one or more 3D models of said object.

19. The system according to claim 11, wherein said one or more processors and/or circuits are operable to configure said monoscopic 3D video generation device to output said 3D images of said object to a display in said monoscopic 3D video generation device.

20. The system according to claim 11, wherein said one or more processors and/or circuits are operable to configure said monoscopic 3D video generation device to output said 3D images of said object externally to a 3D video rendering device for rendering said 3D images of said object.
